(19) United States
(12) Patent Application Publication
(10) Pub. No.: US 2024/0375525 A1
(43) Pub. Date: Nov. 14, 2024

(54) VEHICLE TRAILER AND VEHICLE TRAIN

(71) Applicant: ZF Friedrichshafen AG, Friedrichshafen (DE)

(72) Inventor: Axel Rohm, Schonungen (DE)

(73) Assignee: ZF Friedrichshafen AG, Friedrichshafen (DE)

(21) Appl. No.: 18/659,716

(22) Filed: May 9, 2024

(30) Foreign Application Priority Data
May 12, 2023 (DE) 10 2023 204 447.1

(51) Int. Cl. B60L 15/20; B60K 1/02; B60L 50/60; B62D 59/04; B62D 63/06

(52) U.S. Cl. CPC B60L 15/2009; B60K 1/02; B60L 50/60; B62D 59/04; B62D 63/06; B60L 2200/28; B60L 2240/22; B60L 2240/463

(57) ABSTRACT

A vehicle trailer for a towing vehicle has a first wheel and at least one second wheel. At least one electric auxiliary drive system is coupled to the first wheel and second wheels for exerting a first torque on the first wheel and a second torque on the second wheel(s). The auxiliary drive system is adapted as an electrical auxiliary drive system capable of recuperation with an auxiliary energy storage device. A force measuring device can measure a longitudinal force signal as the longitudinal force exerted by the towing vehicle on the vehicle trailer by means of a connection. A control unit is adapted to adjust the torque to the first and second wheels on the basis of the electric auxiliary drive system and as a function of the longitudinal force, while maintaining a minimum tractive force. The invention also relates to a vehicle train.

### RELATED APPLICATIONS

This application claims the benefit of and right of priority under 35 U.S.C. § 119 to German Patent Application no. 10 2023 204 447.1, filed on 12 May 2023, the contents of which are incorporated herein by reference in its entirety.

### FIELD OF THE DISCLOSURE

The invention relates to a vehicle trailer for a towing vehicle, the vehicle trailer comprising a first wheel and at least one second wheel, as well as at least one electric auxiliary drive system that is coupled to the first wheel and to the at least second wheel for exerting a first torque on the first wheel and a second torque on the at least second wheel. The invention also relates to a vehicle train.

### BACKGROUND

Vehicle trailers are usually pulled/towed passively behind the towing vehicle. The towing power is generated exclusively by the towing vehicle.

In previously used vehicle trailers, a drawbar is mounted in a vertical direction such that during operation, i.e., when driving the towing vehicle with the vehicle trailer, essentially a longitudinal force load is exerted on the towing hitch, i.e., loads that act in the longitudinal direction of the drawbar.

Electrically driven vehicles have a comparatively long range of several hundred kilometers due to their large battery capacity.

However, the range is reduced by approx. 30 to 50% for higher power requirements, such as high speeds or with vehicle trailers (e.g., camper vans). Conventional, internal combustion engine-powered vehicles are also affected by this range reduction, but their energy storage capacity is larger and they are refueled within a few minutes.

For electric vehicles, this is much more time-consuming because the charging capacity is limited. Even at a high-performance charging station, for example, 40 to 60 minutes must often be planned until a sufficient charge status is restored to permit a 90-minute drive.

In addition, the availability of charging stations is limited. In particular, a charging process of electrical energy storage devices, such as battery packs, for operating an electric drive requires significantly more time than is the case when filling a motor vehicle with an internal combustion engine with conventional fuel, such as gasoline or diesel.

For bicycles, so-called push-trailers are known, which allow assisted or electric travel with a bicycle.

DE 10 2019 202784 A1 discloses a trailer for a vehicle that can be connected to the vehicle, having an axis, on which two wheels are movably mounted, one electric motor per wheel that is connected to its wheel by one transmission and one drive shaft each, wherein each electric motor is adapted to be operated either as a generator or motor depending on the driving situation, at least one energy storage device that is connected to the electric motors, at least one control device adapted to control the electric motors, and at least one measuring device adapted to determine a force acting on the trailer and originating from the vehicle, a detection device adapted to determine the type of drive of the vehicle, wherein the control device of the trailer is adapted to individually control the electric motors based on the determined force and based on the determined drive type of the vehicle in order to assist a drive of the vehicle such that a defined force acts on the vehicle.

### SUMMARY

A problem addressed by the invention is to specify a vehicle trailer and a vehicle train that is in particular improved with regard to the range.

The problem is solved by a vehicle trailer having the features of a vehicle trailer and by a vehicle with a vehicle train, as variously disclosed herein.

Additional advantageous measures will be apparent in light of the present disclosure and can be suitably combined with one another in order to achieve further advantages.

The problem is solved by a vehicle trailer for a towing vehicle, the vehicle trailer comprising one first wheel and at least one second wheel, as well as at least one electric auxiliary drive system that is coupled to the first wheel and to the at least second wheel for exerting a first torque on the first wheel and a second torque on the at least second wheel,
wherein the at least one auxiliary drive system is adapted as an electrical auxiliary drive system capable of recuperation with at least one auxiliary energy storage device, and wherein
a longitudinal force measuring device is provided that is adapted to measure a longitudinal force signal as the longitudinal force exerted by the towing vehicle on the vehicle trailer by means of a connection and wherein a control unit is provided that is adapted to adjust the first torque to the first wheel and the second torque to the at least second wheel on the basis of the electric auxiliary drive system and as a function the measured longitudinal force while also maintaining a predefined minimum towing force.

A plurality of auxiliary drive systems can comprise one or more auxiliary energy storage devices, for example auxiliary batteries.

In the simplest case, the first torque and the second torque can be identical.

According to the invention, a vehicle trailer, for example a camper van or truck trailer, is now equipped with its own electric auxiliary drive system and is controlled by a control unit such that, by definition, a vehicle trailer drawn behind the towing vehicle is maintained. The auxiliary drive system is in this case adapted such that a certain minimum tractive force is always maintained on the towing device/towing hitch in order to keep the train under tension. This increases the safety of the entire train.

For this purpose, a longitudinal force measuring device is preferably for example adapted as a sensor for determining the longitudinal force between the towing vehicle and the vehicle trailer for controlling the auxiliary drive system such that the train remains continuously under tension while maintaining the minimum tractive force.

The power range of the auxiliary drive system can for example be adapted between the required towing power/resistance power of the vehicle trailer at speeds up to 100 km/h and a slope of 5 to 10%.

Such an inventive vehicle trailer provides the power requirements of the vehicle trailer in a timely manner. Greater output requirements, for example for a steeper slope, can be provided by the towing vehicle.

The inventive vehicle trailer can therefore be used absolutely safely without additional measures or equipment. Even if the electric auxiliary drive system of the vehicle trailer fails or the charge status of the battery is too low, the vehicle trailer can be moved safely like a conventional vehicle trailer with an overrun brake.

The additional auxiliary drive system can thus be used to assist the acceleration process and can thus contribute toward relieving the traction power required by the towing vehicle.

The inventive vehicle trailer furthermore supports the braking processes of the towing vehicle by recuperation. In addition, recuperation can relieve the trailer brake, especially in gradients, and can thus contribute to the safety of the vehicle trailer-trailer system.

This relieves the brake system of the vehicle trailer under load. During longer gradients, the brake of the towing vehicle can then be relieved by means of an engine braking effect, while also relieving the trailer brake system. This prevents the risk of thermal overload due to a constant load on the trailer brake system.

In a further embodiment, the longitudinal force measuring device is adapted as a force sensor, wherein the force sensor is arranged to detect the entire longitudinal force. For this purpose, the force sensor can for example either be arranged in the hitch or in the drawbar or the frame members, wherein a force sensor is provided in each frame member. This ensures that the total force is recorded, regardless of whether it is distributed equally to both frame members. Recording in one frame member is sufficient if it can be ensured that the drawbar force is evenly distributed on both frame members with an acceptable difference.

The longitudinal force measuring device can furthermore be adapted as a displacement sensor for measuring displacement. This displacement measurement can for example be measured by a spring load in the towing device. If an overrun device for a brake and furthermore a brake linkage is present, the displacement sensor can be arranged on the brake linkage. Such overrun devices are used on braked vehicle trailers, wherein the overrun device actuates the brakes by means of the brake linkage. Such a linkage often extends to one axle and only then transfers the force, for example to the brakes. The displacement sensor can for example be a potentiometer.

The displacement of the linkage is thus directly related to the overrun displacement on the towing device such that the displacement can be measured at each position of the linkage by a displacement sensor.

Furthermore, when the control unit of the axis is arranged suitably, the linkage can for example be controlled by the sensor located in the control unit.

A further embodiment provides that the control unit is adapted to determine a deviation amplitude and/or the change gradient in relation to the longitudinal force, wherein the control unit is further adapted to adjust the first torque to the first wheel and the second torque to the at least second wheel as a function of the deviation amplitude and/or the change gradient and the previously defined minimum tractive force. This applies likewise to a braking process, wherein, depending on the braking capacity of the towing vehicle, the mechanical overrun brake system automatically exerts a part of the total braking power in different proportions parallel to the recuperation if the recuperation power is not sufficient to provide the required braking force.

A further embodiment provides that the control unit is additionally adapted to adjust the first torque on the first wheel and the second torque on the at least second wheel as a function of a drawbar force such that the drawbar force remains constant.

The theoretical drawbar force between the towing vehicle and the vehicle trailer corresponds to the computational comparison value of forces between moving masses. The power of the towing vehicle can thus be controlled such that the drawbar force remains constant.

A further embodiment provides that the control unit is adapted to receive adjustment signals, wherein the control unit is adapted to adjust the first torque on the first wheel and the second torque on the at least second wheel as a function of the received adjustment signal such that an increase or reduction of the drawbar force is achieved.

For example, the driver can manually trigger the adjustment signal, for example with spinning wheels, in which case a thrust force is useful, or set a higher drawbar force, for example while traveling downhill in adverse weather conditions.

Furthermore, it may be necessary to switch off the electric auxiliary drive system, e.g., in the event of emergency braking such that the force ratios can only be controlled by the physical variables themselves. For this purpose, a threshold value with respect to the force increase gradient can be defined, above which the electric auxiliary drive system switches off, for example by disconnecting electrical power.

Thus, for example, the drawbar force can also be negative (thrust force), which means that the vehicle trailer pushes the towing vehicle. This can be useful, for example, in the case of spinning wheels, for example in snow or mud, when the towing vehicle no longer moves forward under its own power. The vehicle trailer can thus push, or transfer additional force to, the towing vehicle.

A further embodiment provides an environmental sensor for recording environmental signals and an analysis unit, for analyzing the environmental signals as environmental data, and wherein the control unit is adapted to adjust—as a function of the environmental data—the first torque on the first wheel and the second torque on the at least second wheel and depending on the drawbar force such that an increase or reduction of the drawbar force is achieved. This permits an automated adjustment, for example, depending on the use case. Higher or lower drawbar forces may make sense, in particular when driving offroad/at construction sites and/or when driving on slopes in adverse weather conditions.

In a further embodiment, the control unit is adapted to achieve the increase or reduction of the drawbar force as a function of a characteristic curve.

This means that the torque is adjusted on the basis of a characteristic curve or characteristic envelope such that the drawbar force is adjusted to different target forces, e.g., depending on the use case.

The auxiliary drive system in particular comprises at least one auxiliary battery as an auxiliary energy storage device and a first electric motor coupled to the auxiliary battery for applying the first torque to the first wheel and a second electric motor coupled to the auxiliary battery for applying the second torque to the second wheel.

A plurality of wheels can furthermore be provided such that a first wheel side and a second wheel side are formed, wherein the auxiliary drive system comprises at least one auxiliary battery as an auxiliary energy storage device and a first electric motor coupled to the auxiliary battery for applying the first torque to the first wheel side and a second electric motor coupled to the auxiliary battery for applying the second torque to the second wheel side. The control unit for example comprises a plurality of control devices for separate electric motors that drive the electric motors separately on the basis of the longitudinal force signal.

A plurality of, for example, at least four wheels can also be provided, of which two are connected by a first dual axis as the first wheel side and by a second dual axis as the second wheel side, and wherein a first electric motor and a second electric motor and one or more auxiliary batteries are provided on the first dual axis. Each electric motor can also have its own auxiliary battery.

This can result in a significant safety gain.

Each of the available wheels can furthermore each comprise an electric motor, wherein at least one or more auxiliary batteries are mapped to the wheels.

At least one electric motor is thus present per wheel side. The control unit then comprises a plurality of control devices for separate electric motors that drive the electric motors separately on the basis of the longitudinal force signal.

A further embodiment provides a detection unit for detecting a yaw torque, wherein the control unit is adapted to generate an additional torque on a corresponding required wheel side and/or an additional braking torque on the opposite wheel side by the first electric motor and/or the at least second electric motor, thus exerting an opposing yaw torque. The detection unit can in particular be adapted as a yaw angle sensor.

When a hazardous situation is detected by/for the vehicle trailer, an opposing yaw torque can be achieved by exerting an additional torque on one side or a braking torque on the opposite side, or simultaneously by both measures, thus stabilizing the towing vehicle.

As a result, a yaw torque can be prevented on the vehicle trailer, e.g., by the road, or by the towing vehicle, for example, by excessive speed, which would usually lead to swaying without these timely countermeasures. This prevents the vehicle from swaying, which can result in jackknifing the vehicle trailer as well as the towing vehicle and in serious accidents.

By recognizing a yaw torque and the timely introduction of an opposing yaw torque, it is also possible to prevented that the driver reacts incorrectly or too late.

Due to the detection unit in combination with the control unit and the exertion of an opposing yaw torque, conventional sway dampers can also be omitted, which generate a friction force on the hitch or on an additional friction device and thus counteract jackknifing the train/the yaw torque.

A further embodiment provides an electrical connection to the towing vehicle, wherein the control unit is adapted to use a supply signal generated by the towing vehicle to accomplish a transfer of energy from the auxiliary energy storage device to the towing vehicle by means of the electrical connection.

A further embodiment provides that the auxiliary energy storage device can be recharged independently of the towing vehicle.

In particular, the vehicle trailer can have a significantly larger battery capacity than is required for the vehicle trailer's power requirement. In the presence of a high-capacity electrical connection between the vehicle trailer and the towing vehicle, at least a variable part of the energy requirement from the auxiliary energy storage device of the vehicle trailer can be provided when the vehicle battery falls below a certain charge state. This can, for example, be transmitted to the control unit of the vehicle trailer by means of the supply signal, which is generated manually by the driver or by the towing vehicle battery of the towing vehicle itself, which then transmits a part of the energy of the auxiliary energy storage device to the towing vehicle or its battery. This can increase the range of the towing vehicle together with the vehicle trailer.

The problem is further solved by a vehicle train with a vehicle trailer as described above with an electric auxiliary drive system and a towing vehicle to which the vehicle trailer is coupled, wherein the towing vehicle is adapted with a vehicle electric motor and wherein the vehicle electric motor has a vehicle energy storage device and the auxiliary drive system has an electric auxiliary energy storage device.

A further embodiment provides that the vehicle energy storage device and the auxiliary energy storage device have the same charging capacity or a larger charging capacity.

As a result, the vehicle and vehicle trailer have the same or as similar a range as possible.

A further embodiment provides a plurality of auxiliary drive systems with a plurality of electrical auxiliary energy storage devices, and wherein the vehicle energy storage devices and each of the auxiliary energy storage devices have the same charging capacity or a larger charging capacity.

As a result, assistance with respect to the energy of the towing vehicle can also be provided as needed.

### BRIEF DESCRIPTION OF THE DRAWINGS

Further features and advantages of the invention arise from the following description with reference to the enclosed figures. The following are shown schematically:

FIG. 1: a vehicle train according to the prior art,

FIG. 2: a first embodiment of a vehicle trailer according to the invention,

FIG. 3 a detection of the tractive force as a displacement measurement.

FIG. 4 a detection of the tractive force as a displacement measurement,

FIG. 5: a further embodiment of an inventive vehicle trailer,

FIG. 6: a further embodiment of an inventive vehicle trailer,

FIG. 7: a further embodiment of an inventive vehicle trailer,

FIG. 8: a further embodiment of an inventive vehicle trailer,

FIG. 9 shows a further embodiment of an inventive vehicle trailer.

### DETAILED DESCRIPTION

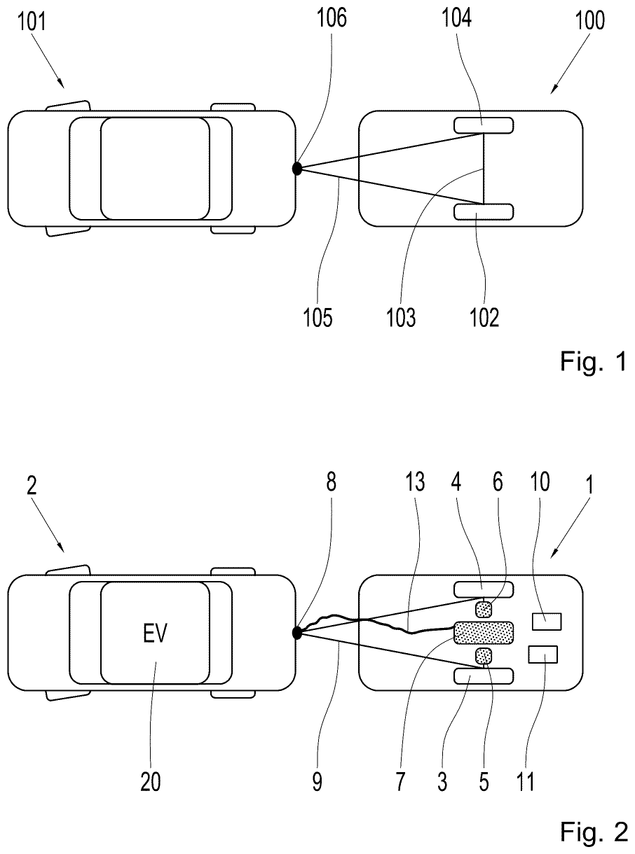

FIG. 1 shows a schematic illustration of a vehicle train with a passive vehicle trailer 100 and a towing vehicle 101 according to the prior art. The towing vehicle 101 pulls the vehicle trailer 100 in the direction of travel. The vehicle trailer 100 comprises an axle 103 to which a first wheel 102 and a second wheel 104 are connected. The wheels 102, 104 are movably mounted on the axle 103. The vehicle trailer 100 comprises a drawbar 105 (towing drawbar), by means of which it is connected to a trailer hitch 106 of the towing vehicle 101. The vehicle trailer 100 is thus attached to the towing vehicle 101. The vehicle trailer 100 is thus passively pulled/towed behind the towing vehicle 101. The towing power is generated exclusively by the towing vehicle 101.

FIG. 2 shows a first embodiment of the invention. This comprises a vehicle trailer 1 and an electrically operated towing vehicle 2 with a vehicle electric motor 20. The vehicle trailer 1 is coupled to the electrically operated towing vehicle 2 by a drawbar 9 and a hitch 8. In operational use, i.e., when driving the towing vehicle 2 with the vehicle trailer 1, essentially a longitudinal force load is exerted on the hitch 8, i.e., loads that act in the longitudinal direction of the drawbar 9.

The vehicle trailer 1 comprises at least a first wheel 3 and a second wheel 4, each of which comprise two transmissions, two drive shafts and, as an auxiliary drive system, a first electric motor 5 and a second electric motor 6, wherein a first torque can be applied to the first wheel 3 using the first electric motor 5 and a second torque can be applied to the second wheel 4 using the second electric motor 6.

The vehicle trailer 1 further comprises an electrical energy storage device, in this case an auxiliary battery 7.

The first electric motor 5 is connected to the energy storage device, in this case to the auxiliary battery 7. If the first wheel 3 is now driven, energy is transferred from the auxiliary battery 7 to the first electric motor 5. The latter provides a torque that is transmitted to, and converted by, the first transmission. The first transmission transmits the torque to the first drive shaft. The latter transmits the torque to the first wheel 3. The second wheel 4 is operated likewise. The energy is transmitted from the auxiliary battery 7 to the second electric motor 6. The latter provides a torque that is transmitted to, and converted by, the second transmission. The second transmission transmits the second torque to the second drive shaft. The latter transmits the second torque to the second wheel 4.

Furthermore, a sensor 11 is provided as a longitudinal force measuring device.

This sensor 11 is used to determine the longitudinal force acting between the towing vehicle 2 and the vehicle trailer 1. The longitudinal force can be detected in different ways, e.g., directly as a force measurement or as a displacement measurement, for example by a spring load in the towing device.

For this purpose, the sensor 11 can for example be adapted as a force sensor. The force sensor is positioned where the entire tractive force can be detected, for example on the hitch 8, on the drawbar 9 or on the frame members 21, wherein a sensor 11 is required in each frame member 21 to ensure that both frame members 21 detect an identical load.

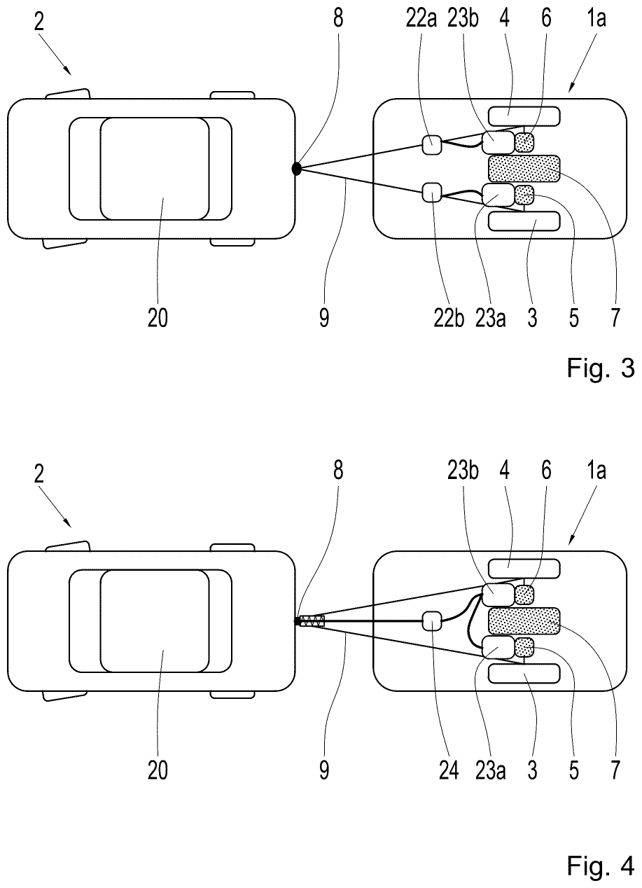

FIG. 3 shows a sensor arranged as a force sensor 22a, 22b on each frame member 21. The latter transmits the respective tractive force measurement to a control unit 10, which in this case is adapted as two control devices 23a, 23b, for adjusting the respective electric motor 5,6.

Alternatively, or additionally, the sensor 11 can be adapted as a displacement sensor. If an overrun device for a brake and furthermore a brake linkage is present, the displacement sensor can be arranged on the brake linkage. Such overrun devices are used on braked vehicle trailers, wherein the overrun device actuates the brakes by means of the brake linkage. Such a linkage often extends to one axle and only then transfers the force, for example to the brakes.

FIG. 4 shows the detection of the tractive force as a displacement measurement by measuring a spring load in the towing device by a force gauge 24, for example a potentiometer. The latter transmits the tractive force measurement to the control unit 10, which in this case comprises the two control devices 23a, 23b for adjusting the respective electric motor 5,6.

The displacement of the linkage is thus directly related to the overrun displacement on the towing device such that the displacement can be measured at each position of the linkage.

It is further conceivable that the arrangement of a control unit 10, for example on the axis, allows the linkage to be guided, for example, by the sensor 11, which can thus be arranged in the control unit 10.

The control unit 10 is likewise present to determine a deviation amplitude and/or the change gradient with respect to the longitudinal force. For this purpose, the control unit 10 can comprise an analysis unit.

The control unit 10 then determines a signal depending on the deviation amplitude and/or the change gradient with respect to the longitudinal force and a predetermined minimum tractive force, based on which the first electric motor 5 and the second electric motor 6 adjust the first torque on the first wheel 3 and the second torque on the at least second wheel 4.

This means that the first torque and the second torque are adjusted such that a certain minimum tractive force is always maintained on the towing device/drawbar.

Such a minimum tractive force is advantageously 200N. This is sufficient and adequate to ensure that a vehicle trailer 1 remains under tension as defined.

The control unit 10 is adapted to adjust the first torque on the first wheel 3 and the second torque on the at least second wheel 4 such that the drawbar force remains constant.

When receiving an adjustment signal, the control unit 10 can adjust a higher or lower drawbar force by means of a characteristic curve or characteristic envelope, e.g., depending on the use case, etc., by means of a corresponding torque.

Higher or lower drawbar forces may make sense, in particular when driving offroad/at construction sites and/or when driving on slopes in adverse weather conditions.

This applies likewise to a braking process, wherein, depending on the braking capacity of the electric motors 5,6, the mechanical overrun brake system automatically exerts a part of the total braking power in different proportions parallel to the recuperation if the recuperation power is not sufficient to provide the required braking force.

A vehicle trailer 1 adapted in this manner can therefore be used absolutely safely without additional measures or facilities. Even if the electric auxiliary drive system of the vehicle trailer 1 fails or the charging capacity of the auxiliary battery 7 is too low, the towing vehicle 2 can safely move the vehicle trailer 1 like a conventional vehicle trailer with an overrun brake.

The vehicle trailer 1 preferably comprises a driven axle on which the electric motors 5,6 are arranged. The power range of the electric auxiliary drive system must in particular be adapted between the required tractive power/resistance power of the vehicle trailer 1 at speeds up to 100 km/h and a slope of 5 to 10%.

A momentary power requirement of the vehicle trailer 1 can be provided in a timely manner by the inventive vehicle trailer 1. Greater output requirements, for example for a steeper slope, can be provided by the towing vehicle 2.

The inventive vehicle trailer 1 can thus be used in particular to assist the acceleration process and thus serves to relieve the tractive power required by the towing vehicle 2.

By adapting the vehicle trailer 1 according to the invention and the auxiliary drive system, the trailer brake can also be relieved, especially in gradients, in addition assisting the braking processes by recuperation.

The size of the auxiliary battery 7 in the vehicle trailer 1 is adapted such that the range of the towing vehicle 2 and the vehicle trailer 1 is as equal as possible, wherein the range of the vehicle trailer 1 can tend to be smaller than that of the towing vehicle 2, because the vehicle trailer 1 can also be operated as a conventionally towed vehicle trailer.

This makes it possible, for example, to cover a distance of approx. 450 to 500 km with an electric vehicle as the towing vehicle 2, which corresponds to a travel time of approx. 4 to 5 hours.

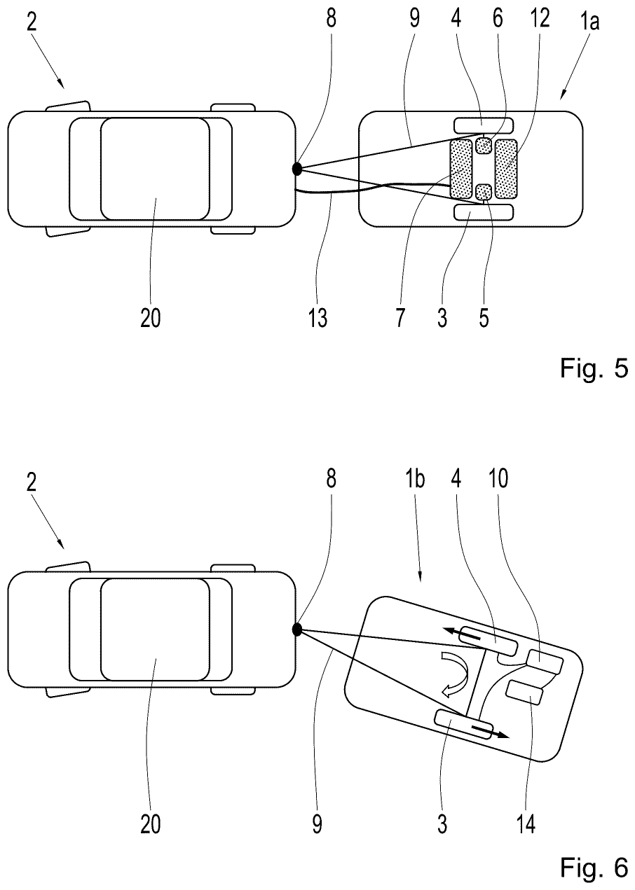

FIG. 5 shows a further embodiment of an inventive vehicle trailer 1a.

The latter comprises the vehicle trailer 1a and the electrically operated towing vehicle 2. The vehicle trailer 1a is coupled to the electrically operated towing vehicle 2 by the drawbar 9 and the hitch 8. The vehicle trailer 1 comprises at least the first wheel 3 and the second wheel 4.

The vehicle trailer 1a further comprises two electric motors 5,6 for applying a first torque to the first wheel 3 and a second torque to the second wheel 4.

Furthermore, the sensor 11 is provided as a longitudinal force measuring device along with the control unit 10. The control unit 10 then determines a signal as a function of the deviation amplitude and/or the change gradient of the longitudinal force as well as a predetermined minimum tractive force, on the basis of which the first electric motor 5 adjusts the first torque on the first wheel 3 and the second electric motor 6 adjusts the second torque on the at least second wheel 4.

Furthermore, the first auxiliary battery 7 and a second auxiliary battery 12 are provided.

As a result, the vehicle trailer 1a has a significantly larger battery capacity than is required for the power requirement of the vehicle trailer 1a.

There is also a correspondingly powerful electrical connection 13 between the vehicle trailer 1a and the towing vehicle 2 such that at least a variable part of the energy requirement from the first auxiliary battery 7 and/or the second auxiliary battery 12 of the vehicle trailer 1 can be made available to the towing vehicle 2 when the towing vehicle battery falls below a certain charge status.

This energy requirements can, for example, be transferred to the towing vehicle 2 according to a supply signal detected by the control unit 10 that is either generated manually by the driver or by the towing vehicle battery of the towing vehicle 2 itself in an automated manner.

The two auxiliary batteries 7, 12 can be recharged independently of the towing vehicle 2 over a longer period of time after decoupling the vehicle trailer 1a. This can be favorable, for example, for rental trailers, which are only rented with the corresponding towing vehicle 2 as needed and are returned to the site and only rented when needed again.

FIG. 6 shows a first embodiment of the invention. The latter comprises the vehicle trailer 1b and the electrically operated towing vehicle 2. The vehicle trailer 1b is coupled to the electrically operated towing vehicle 2 by the drawbar 9 and the hitch 8. The vehicle trailer 1b comprises at least the first wheel 3 and the second wheel 4.

Furthermore, the sensor 11 is provided as a longitudinal force measuring device along with the control unit 10. The control unit 10 then determines a signal as a function of the deviation amplitude and/or the change gradient in relation to the longitudinal force as well as a predetermined minimum tractive force, on the basis of which the first electric motor 5 adjusts the first torque on the first wheel 3 and the second electric motor 5 adjusts the second torque on the at least second wheel 4.

In addition, a yaw angle sensor 14 is provided for detecting a yaw torque.

A hazardous situation can be detected in the vehicle trailer 1b by the yaw angle sensor 14 and an opposing yaw torque can be exerted by exerting an additional torque on one side or a braking torque on the opposite side, or by both measures simultaneously, thus stabilizing the towing vehicle 2.

As a result, a yaw torque can be prevented, for example, by the road or by the towing vehicle 2, for example due to high speed, which usually leads to swaying without timely countermeasures. This prevents the vehicle from swaying, which can result in jackknifing the vehicle trailer 1b as well as the towing vehicle 2 and in serious accidents.

By recognizing a yaw torque and the timely exertion of an opposing yaw torque, it is possible to prevent that the driver reacts incorrectly or too late.

By exerting an opposing yaw torque by the control unit 10 using the first electric motor 5 and the second electric motor 6, conventional sway dampers can thus also be omitted, which generate a friction force on the hitch and thus counteract jackknifing the train/the yaw torque.

As a result, a significant safety gain can be achieved, because an escalation of the situation or even a loss of control over the tractor/trailer or jackknifing the tractor/trailer, thus avoiding a serious accident based on the exerted opposing yaw torque.

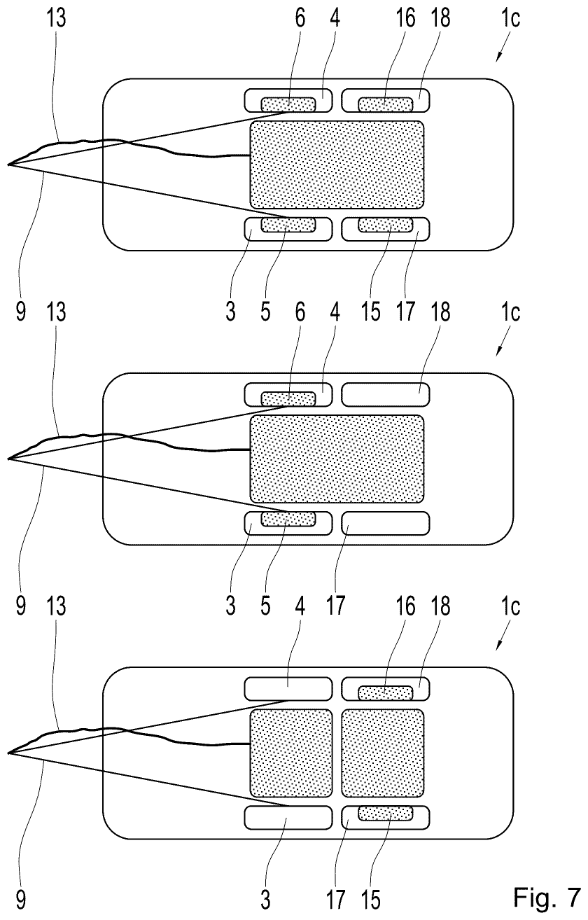

FIG. 7 shows a further embodiment of the invention.

The latter comprises the vehicle trailer and the electrically operated towing vehicle 2. The vehicle trailer is respectively adapted as a dual-axle vehicle trailer 1c. This can be a dual-axle vehicle trailer 1c with four electric motors, a first electric motor 5 for the first wheel 3, a second electric motor 6 for the second wheel 4, a third electric motor 15 for the third wheel 17 and a fourth electric motor 16 for the fourth wheel 18.

It can also be a dual-axle vehicle trailer with two electric motors, namely a first electric motor 5 for the first wheel 3 and a second electric motor 6 for the second wheel 4, wherein the first wheel 4 and the second wheel 5 are adapted as front wheels.

Furthermore, this can be a dual-axle vehicle trailer 1c with two electric motors, namely a third electric motor 15 for the third wheel 17 and a fourth electric motor 16 for the fourth wheel 18, wherein the third wheel 4 and the fourth wheel 18 are adapted as rear wheels.

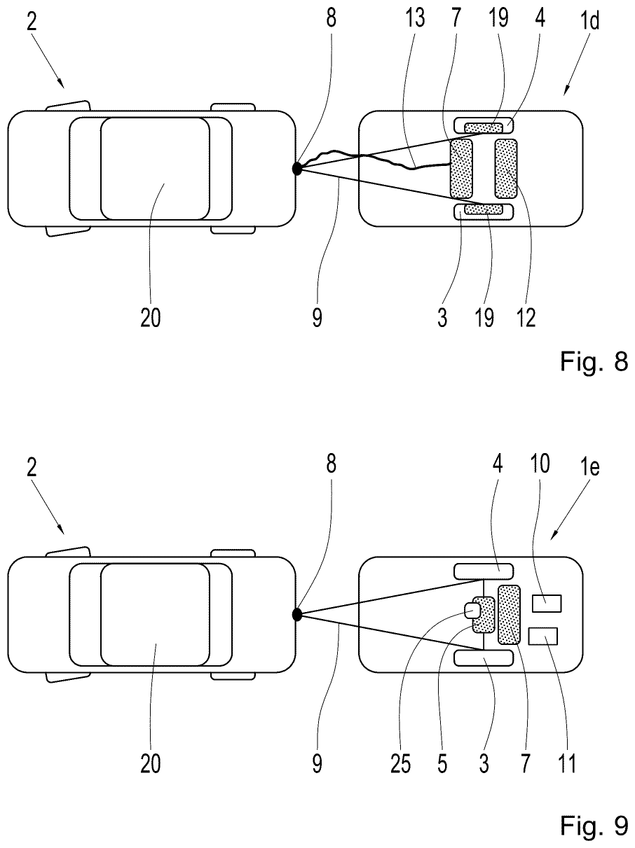

FIG. 8 shows a further embodiment of the invention. The latter comprises the vehicle trailer 1d and the electrically operated towing vehicle 2. The vehicle trailer 1d is adapted with wheel hub motors 19 and a first auxiliary battery 7 and a second auxiliary battery 12.

FIG. 9 shows a further embodiment of the invention. The latter comprises the vehicle trailer 1e and the electrically operated towing vehicle 2. The vehicle trailer 1e is adapted with a differential 25 and an auxiliary battery 7. Due to the presence of a differential 25, the vehicle trailer 1e only requires a first electric motor 5.

All exemplary embodiments can be combined with each other, where possible.

### LIST OF REFERENCE NUMERALS

100 Vehicle trailer
101 Towing vehicle
102 First wheel
103 Axle
104 Second wheel
105 Drawbar
106 Trailer hitch
1, 1a . . . , 1e Vehicle trailer
2 Towing vehicle
3 First wheel
4 Second wheel
5 First electric motor
6 Second electric motor
7 Auxiliary battery
8 Hitch
9 Drawbar
10 Control unit
11 Sensor
12 Second auxiliary battery
13 Electrical connection
14 Yaw angle sensor
15 Third electric motor
16 Fourth electric motor
17 Third wheel
18 Fourth wheel
19 Wheel hub motor
20 Vehicle electric engine
21 Frame members
22a,22b Force sensor
23a,23b Control units
24 Force measuring device
25 Differential

1. A vehicle trailer (1, 1a . . . , 1e) for a towing vehicle (2), the vehicle trailer (1, 1a . . . , 1e) comprising:
a first wheel (3) and at least one second wheel (4);
at least one electric auxiliary drive system coupled to the first wheel (3) and the at least one second wheel (4), the at least one electric auxiliary drive system configured for exerting a first torque on the first wheel (3) and a second torque on the at least one second wheel (4), wherein the at least one auxiliary drive system is adapted as an electric auxiliary drive system capable of recuperation with at least one auxiliary energy storage device;
a longitudinal force measuring device is provided that is adapted to measure a longitudinal force signal as the longitudinal force exerted by the towing vehicle (2) on the vehicle trailer (1, 1a . . . , 1e) by means of a connection; and
a control unit (10) is provided that is adapted to adjust the first torque to the first wheel (3) and the second torque to the at least second wheel (4) on the basis of the electric auxiliary drive system and as a function of the longitudinal force, while also maintaining a predefined minimum tractive force.

2. The vehicle trailer (1, 1a . . . , 1e) according to claim 1, wherein the control unit (10) is adapted to determine a deviation amplitude and/or the change gradient in relation to the longitudinal force, and wherein the control unit (10) is adapted to adjust the first torque to the first wheel (3) and the second torque to the at least second wheel (4) as a function of the deviation amplitude and/or the change gradient and the previously defined minimum tractive force.

3. The vehicle trailer (1, 1a . . . , 1e) according to claim 2, wherein the control unit (10) is adapted to adjust the first torque on the first wheel (3) and the second torque on the at least second wheel (4) as a function of a drawbar force such that the drawbar force remains constant.

4. The vehicle trailer (1, 1a . . . , 1e) according to claim 2, wherein—the control unit (10) is adapted to receive adjustment signals, wherein the control unit (10) is adapted to adjust the first torque on the first wheel (3) and the second torque on the at least second wheel (4) as a function of the received adjustment signal such that an increase or reduction of the drawbar force is achieved.

5. The vehicle trailer (1, 1a . . . , 1e) according to claim 4, comprising:
an environmental sensor configured for recording environmental signals; and
an analysis unit configured for analyzing the environmental signals as environmental data, wherein the control unit (10) is adapted to adjust—as a function of the environmental data—the first torque on the first wheel (3) and the second torque on the at least second wheel (4) and based on the drawbar force such that an increase or reduction of the drawbar force is achieved.

6. The vehicle trailer (1, 1a . . . , 1e) according to claim 5, wherein the control unit (10) is adapted to achieve the increase or reduction of the drawbar force as a function of a characteristic curve.

7. The vehicle trailer (1, 1a . . . , 1e) according to claim 1, wherein the auxiliary energy storage device includes at least one auxiliary battery (7) and a first electric motor (5) coupled to the at least one auxiliary battery (7) for applying the first torque to the first wheel (3) and a second electric motor (6) coupled to the at least one auxiliary energy storage device (7) for applying the second torque to the second wheel (4).

8. The vehicle trailer (1, 1a . . . , 1e) according to claim 7, comprising:
a plurality of wheels having first wheel side and a second wheel side, wherein the at least one auxiliary energy storage device includes at least one auxiliary battery (7) as an energy storage device and a first electric motor (5) coupled to the at least one auxiliary battery (7) for applying the first torque to the first wheel side and a second electric motor (6) coupled to the at least one auxiliary battery (7) for applying the second torque to the second wheel side.

9. The vehicle trailer (1, 1a . . . , 1e) according to claim 7, comprising:
a detection unit configured for detecting a yaw torque, wherein the control unit (10) is adapted to generate an additional torque on a corresponding required wheel side and/or an additional braking torque on the opposite wheel side by the first electric motor (5) and/or the at least second electric motor (6), thus exerting an opposing yaw torque.

10. The vehicle trailer (1, 1a . . . , 1e) according to claim 9, wherein the detection unit is adapted as a yaw angle sensor (14).

11. The vehicle trailer (1, 1a . . . , 1e) according to claim 1, comprising:
an electrical connection (13) to the towing vehicle (2) wherein the control unit (10) is adapted to use a supply signal generated by the towing vehicle (2) to accomplish a transfer of energy from the auxiliary energy storage device to the towing vehicle (2) by means of the electrical connection (13).

12. The vehicle trailer (1, 1a . . . , 1e) according to claim 1, wherein the at least one auxiliary energy storage device can be recharged independently of the towing vehicle (2).

13. A vehicle train comprising:
the vehicle trailer (1, 1a . . . , 1e) according to claim 1;
an electric auxiliary drive system; and
a towing vehicle (2) to which the vehicle trailer (1, 1a . . . , 1e) is coupled;
wherein the towing vehicle (2) is adapted with a vehicle electric motor (20) and wherein the vehicle electric motor (20) comprises a vehicle energy storage device and the auxiliary drive system comprises an electrical auxiliary energy storage device.

14. The vehicle train according to claim 13, wherein the vehicle energy storage device and the at least one auxiliary energy storage device have the same charging capacity or a larger charging capacity.

15. The vehicle train according to claim 13, comprising a plurality of auxiliary drive systems with a plurality of electrical auxiliary energy storage devices, and wherein the vehicle energy storage devices and each of the plurality of auxiliary energy storage devices has the same charging capacity or a larger charging capacity.
